(19) United States
(12) Patent Application Publication
(10) Pub. No.: US 2005/0253590 A1
(43) Pub. Date: Nov. 17, 2005

(54) Battery charge testing apparatus

(76) Inventor: John Sutherland, Waseca (CA)

Correspondence Address: DAVIS & BUJOLD, P.L.L.C., FOURTH FLOOR, 500 N. COMMERCIAL STREET, MANCHESTER, NH, 03101-1151, US

(21) Appl. No.: 11/112,298

(22) Filed: Apr. 22, 2005

(30) Foreign Application Priority Data
May 17, 2004 (CA) 2,470,516

(51) Int. Cl. G01N 27/416

(52) U.S. Cl. 324/426

(57) ABSTRACT

A method and apparatus for testing a charge of a battery. The battery which is to be tested is connected to a device which generates at least one of tactile vibrations or auditory vibrations. A magnitude of a charge of the battery is determined by a magnitude of vibrations generated.

### FIELD OF THE INVENTION

The present invention relates to a testing apparatus which may be used to determine whether a battery is adequately charged.

### BACKGROUND OF THE INVENTION

There are various battery charge testing apparatus which provide a visual indication as to whether a battery is adequately charged. U.S. Pat. No. 2,081,656 (Anthony 1937) discloses a carton for holding batteries, which was developed so that the batteries could be tested without removing them from the carton. The battery charge testing apparatus illustrated for testing the batteries illuminates a light bulb. The intensity of light from the light bulb being indicative of the strength of the battery's charge. A drawback of such a tester is that there can sometimes be difficulty in distinguishing the relative strength of the light in bright daylight conditions. U.S. Pat. No. 1,337,160 (Reibeth 1920) discloses a battery charge testing apparatus having a needle, which moves along a scale to give an indication as to the strength of the battery's charge. A drawback of such a tester is that it is not suitable for use by the vision impaired or under poor lighting conditions.

### SUMMARY OF THE INVENTION

According to the present invention there is provided a method of testing a charge of a battery, comprising the step of connecting a battery which is to be tested to a device which generates at least one of tactile vibrations or auditory vibrations and determining a magnitude of a charge of the battery by a magnitude of vibrations generated by the vibrator.

With the above described method and the battery charge testing apparatus, as described above, the person testing the battery receives a tactile or auditory sensation. The person can determine the strength of the charge of the battery from the strength of the sensation. The tester is suitable for use with persons having impaired vision and the results of the test can be interpreted by persons having good vision without regard to ambient lighting conditions.

### BRIEF DESCRIPTION OF THE DRAWINGS

These and other features of the invention will become more apparent from the following description in which reference is made to the appended drawings, the drawings are for the purpose of illustration only and are not intended to in any way limit the scope of the invention to the particular embodiment or embodiments shown, wherein:

FIG. 1 is a perspective view of a first embodiment of battery charge testing apparatus constructed in accordance with the teachings of the present invention.

FIG. 2 is a perspective view of a second embodiment of battery charge testing apparatus constructed in accordance with the teachings of the present invention

### DETAILED DESCRIPTION OF THE PREFERRED EMBODIMENT

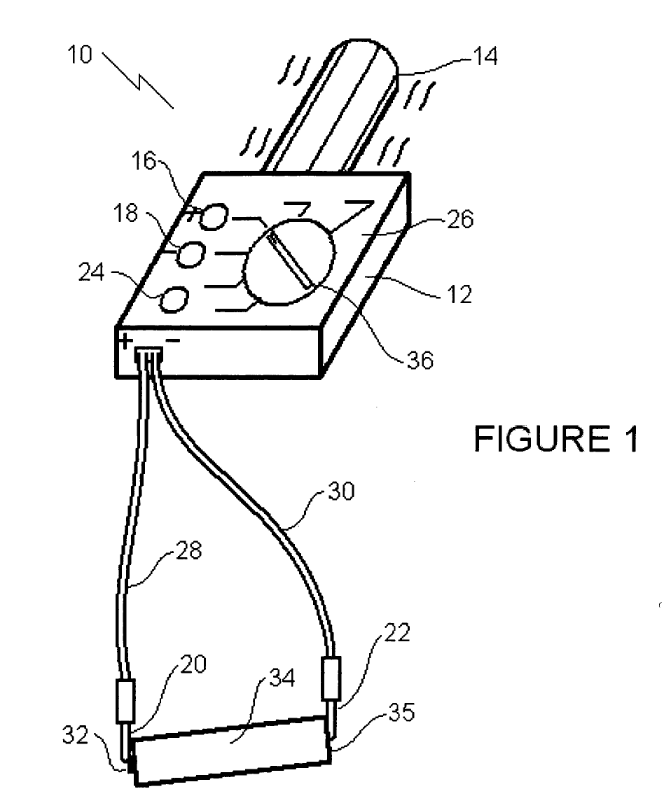

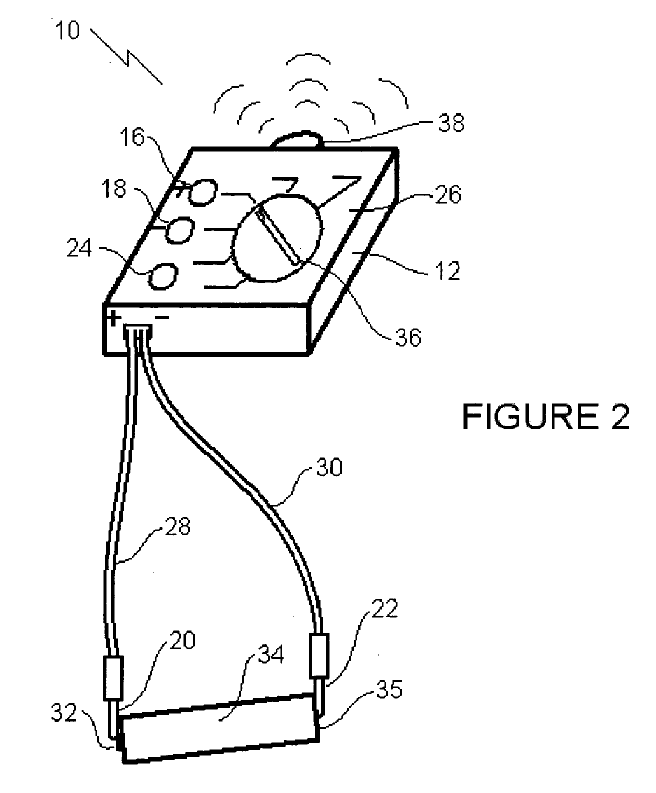

The preferred embodiment, a battery charge testing apparatus generally identified by reference numeral 10, will now be described with reference to FIGS. 1 and 2.

Structure and Relationship of Parts:

Referring now to FIG. 1, there is shown battery charge testing apparatus 10.

Battery charge testing apparatus 10 comprises a body 12 with a vibrator 14 mounted to body 12. An electrical circuit (not shown) is in body 12 to supply power to vibrator 14. External contacts 16, 18, 20, 22, and 24 are connected to the electrical circuit. External contacts 16 and 18, which may be referred to as a first and second contact, respectively, are positioned on an external surface 26 of body 12. External contacts 20 and 22, which may also be referred to as a first and second contact, respectively, are positioned on a first umbilical cord 28 extending from body 12 and a second umbilical cord 30 extending from body 12, respectively. When either first external electrical contact 16 or 20 is in contact with a first pole 32 of a battery 34 and either second external electrical contact 18 or 22 is in contact with a second pole 35 of battery 34, vibrator 14 vibrates with a magnitude of a charge of battery 34 determining a magnitude of the vibrations. As shown in FIG. 1, battery 34 is connected to external electrical contacts 20 and 22. External contacts 16 and 18 are more suitable for a battery such as a 9V battery. Alternatively, external contacts 16 and 18 may be positioned vertically on body 12 and be facing each other at an appropriate distance to receive a battery such as an AA battery. External contact 24 is capable of testing a battery such as a watch battery, with only one conducting side.

Battery charge testing apparatus 10 may also includes more than one electrical circuit (not shown) with a selector switch 36 positioned on external surface 28 of body 12 to select one of the electrical circuits depending upon the type of battery to be tested. While selector switch 36 is shown to be rotatable, it could also be a switch that slid laterally. If the tester is intended for use by someone visually impaired, the selector switch may have raised indications on body 12.

Operation:

The method of operation of battery charge testing apparatus will now be discussed with reference to FIG. 1. When a battery is to be tested, selector switch 36 is moved to the appropriate electrical circuit. Battery 34 is put into contact with electrical contacts 16 and 18, 20 and 22, or 24, and the charge of battery 34 is judged based upon the vibrations of vibrator 14.

Variations:

Referring to FIG. 2, there is illustrated an alternative embodiment of battery tester. In this embodiment, identical reference numerals are used to designate identical features, thereby reducing the description of the structure and the operation of the device.

The overall inventive concept is to generate vibrations that a person with limited vision or in poor lighting conditions can sense. The first embodiment generated tactile vibrations, that a person using the device can feel. This second embodiment generates auditory vibrations, that a person using the device can hear. To facilitate the generation of auditory vibrations, a sound generator 38 is shown replacing vibrator 14. In all other respects the device is the same. Of course, both tactile and auditory vibrations may be generated to provide the benefits of both.

In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be one and only one of the elements.

It will be apparent to one skilled in the art that modifications may be made to the illustrated embodiment without departing from the spirit and scope of the invention as hereinafter defined in the Claims.

1. A method of testing a charge of a battery, comprising the step of:
connecting a battery which is to be tested to a device which generates at least one of tactile vibrations or auditory vibrations and determining a magnitude of a charge of the battery by a magnitude of vibrations generated by the vibrator.

2. A battery charge testing apparatus constructed in accordance with the teachings of the method of claim 1.

3. The battery charge testing apparatus as defined in claim 2, comprising:
a body;
a vibrator mounted to the body adapted to generate at least one of tactile vibrations or auditory vibrations;
an electrical circuit in the body supplying power to the vibrator;
a first external electrical contact connected to the electrical circuit;
a second external electrical contact connected to the electrical circuit, such that when the first external electrical contact is in contact with a first pole of a battery and the second external electrical contact is in contact with a second pole of the battery, the vibrator vibrates with a magnitude of a charge of the battery determining a magnitude of the vibrations.

4. The battery charge testing apparatus as defined in claim 3, wherein the first external electrical contact and the second external electrical contact are positioned on an external surface of the body.

5. The battery charge testing apparatus as defined in claim 3, wherein the first external electrical contact is positioned on a first umbilical cord extending from the body and the second external electrical contact is positioned on a second umbilical cord extending from the body.

6. The battery charge testing apparatus as defined in claim 3, wherein the body has more than one electrical circuit and a selector switch is positioned on an external surface of the body to select one of the more than one electrical circuits depending upon the type of battery to be tested.

7. The battery charge testing apparatus as defined in claim 3, wherein the vibrator generates tactile vibrations.

8. The battery charge testing apparatus as defined in claim 3, wherein the vibrator generates auditory vibrations.

9. The battery charge testing apparatus as defined in claim 3, wherein the vibrator generates both tactile vibrations and auditory vibrations.
